(19) United States
(12) Patent Application Publication
(10) Pub. No.: US 2013/0311440 A1
(43) Pub. Date: Nov. 21, 2013

(54) COMPARISON SEARCH QUERIES

(71) Applicants: Charles A. Cole, Cary, NC (US); David B. Roberts, Cary, NC (US); Eric Woods, Durham, NC (US)

(72) Inventors: Charles A. Cole, Cary, NC (US); David B. Roberts, Cary, NC (US); Eric Woods, Durham, NC (US)

(73) Assignee: INTERNATIONAL BUSINESS MACHINES CORPORATION, Armonk, NY (US)

(21) Appl. No.: 13/472,426

(22) Filed: May 15, 2012

(51) Int. Cl. G06F 17/30

(52) U.S. Cl. 707/709; 707/722; 707/E17.108

(57) ABSTRACT

A computer implemented method, system and computer program product for providing search results in response to a search query includes receiving, by a processor, a search query from a user. A processor detects that the search query includes a request for a comparison-mode query and the processor automatically detects terms in the search query indicating that the query includes components. The comparison-mode query is decomposed into respective, individual component queries for the respective components and the query is performed as respective component queries for the respective, individual components. This includes finding an individual result for each respective, individual component from a single, remote website. The user is presented the individual results of the component queries, which includes aligning the results side-by-side and vertically, so that although the results are for respective, individual components, the alignment tends to help the user compare the individual results.

### BACKGROUND

Traditional search engines, such as Google, have a single input box in which users may input a search query. In response to receiving a query a search engine identifies and returns search results (i.e. hosted web pages) that are relevant to the search query. For queries about products or services, individual reviews of individual products, services, etc are often included in the results. Sometimes results include reviews found that compare one product or service to another.

### SUMMARY

According to an embodiment of the invention, a method for providing search results in response to a search query includes receiving, by a processor, a search query from a user and detecting, by the processor, that the search query includes a request for a comparison-mode query and the processor automatically detecting terms in the search query indicating that the query includes components.

The method further includes decomposing the comparison-mode query into respective, individual component queries for the respective components, and performing the comparison-mode query.

Further, performing the comparison-mode query includes performing the respective component queries for the respective, individual components, including finding an individual result for each respective, individual component from a single, remote website.

Performing the comparison-mode query also includes presenting to the user the individual results of the component queries, including aligning the results from the single website side-by-side and vertically, so that the alignment of results from the single website tends to help the user compare the individual results, although the results from the single website are for respective, individual components.

Other embodiments of the invention are disclosed and claimed, including implementations in a computer system and a program product.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to an embodiment of the invention.

FIG. 2 is an exemplary block diagram of a server apparatus according to an embodiment of the invention.

FIG. 3 is an exemplary block diagram of a client apparatus according to an embodiment of the invention.

FIG. 4 illustrates search engine-related modules and data on a search provider's system in relation to web pages stored on a remote host system accessible via the Internet, according to an embodiment of the present invention.

FIG. 5 illustrates shows an example search result that sets out first and second product or service reviews in alignment, according to an embodiment of the present invention.

FIG. 6 illustrates a search related process, according to an embodiment of the invention.

FIG. 7 shows an example search result for a query for comparison of two cameras, according to an embodiment of the present invention.

### DETAILED DESCRIPTION

When users seek to compare products, they tend to form search queries by combining product names into a single query string for the purpose of comparison, such as, for example, “product A versus product B.” In an embodiment of the present invention, this may be seen as two independent searches (namely “product A” and “product B”) each with their own set of search results (reviews, documentation, retailers, etc). Accordingly, a query pre-processor recognizes a search query having independent components, decomposes the query into those components, and causes a search engine to perform concurrent searches on each component. Once the search engine produces a list of relevant results for each query component, a query postprocessor or preview processor formats and displays them to the user in a fashion such that the user may directly compare the results to one another. These results may be displayed as previews in a results list, as will be further described herein below.

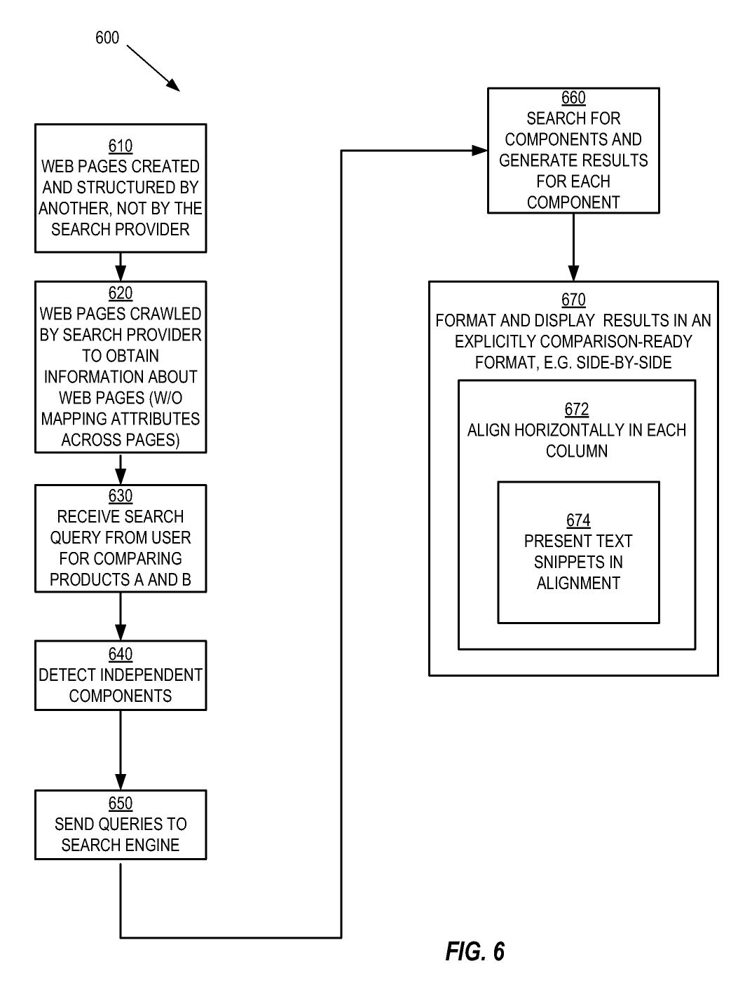

Referring now to FIG. 6, a search related process 600 is illustrated, according to an embodiment of the invention. FIG. 6 is a flowchart of the representative process 600, which arises from execution of instructions residing in one or more processing modules of at least one computer system, such as described herein.

In process 600, a user interface receives 630 a search query from a user for comparing products A and B to one another: “product A versus product B.” In response, a search engine preprocessor detects 640 that the query is composed of independent components and decomposes the query into those components (i.e., “product A” and “product B”). To detect and decompose independent query components, known techniques may be used. For example, the preprocessor can perform processing to detect comparison responsive to words or phrases in the query, such as “versus,” “or,” “better than,” “compared to,” including detecting by natural language patterns such as “compare . . . to . . . ,” etc. Alternatively, the search engine may receive an explicit indication from the user that the query is for a comparison of components, i.e., a manual indication, such as, e.g., via a user selected check box.

The preprocessor sends 650 the queries to the search engine, which causes the search engine to perform 660 searches for the components and generate results for each component, i.e., search and find results for the individual “product A” and for the individual “product B.” The searches may be performed concurrently. A search engine postprocessor formats and displays 670 the results in an explicitly comparison-ready format, such as, for example, side-by-side vertical columns for respective components.

That is, for example, the postprocessor formats and then displays the results for

Product A in one vertical column and the results for Product B in another vertical column, side-by-side.

Further, in another aspect of process 600 in FIG. 6, processing 670 includes the postprocessor formatting and displaying 672 the results from the same service for each query component aligned horizontally in each column. That is, in the above terminology, www.yelp.com is considered to be a “service.” Accordingly, if www.yelp.com has reviews for Product A and Product B, the postprocessor also horizontally aligns results for the products from www.yelp.com next to each other for quick comparison. For example, responsive to receiving a user query for “Restaurant A versus Restaurant B,” the search engine finds individual results from www.yelp.com, such as, one result for individual Restaurant A and one result for individual Restaurant B, i.e., not a single web page prepared by www.yelp.com explicitly comparing Restaurants A and B.

Further, in another aspect of an embodiment, processing 670 includes the search engine postprocessor finding, formatting for alignment, and presenting in alignment 674 snippets of text that complement one another within the results. For example, the postprocessor may find result data that shares a service-related topic in common, wherein the result data for Restaurant A says “The service is great; very friendly and very fast” and result data for Restaurant B says “The service is slow, but the people are nice.” Since these snippets relate to the same topic, postprocessor aligns them in the result comparison, which may be a preview result. Alternatively, the search engine may search for text snippets that share topics in common as part of the comparison search query.

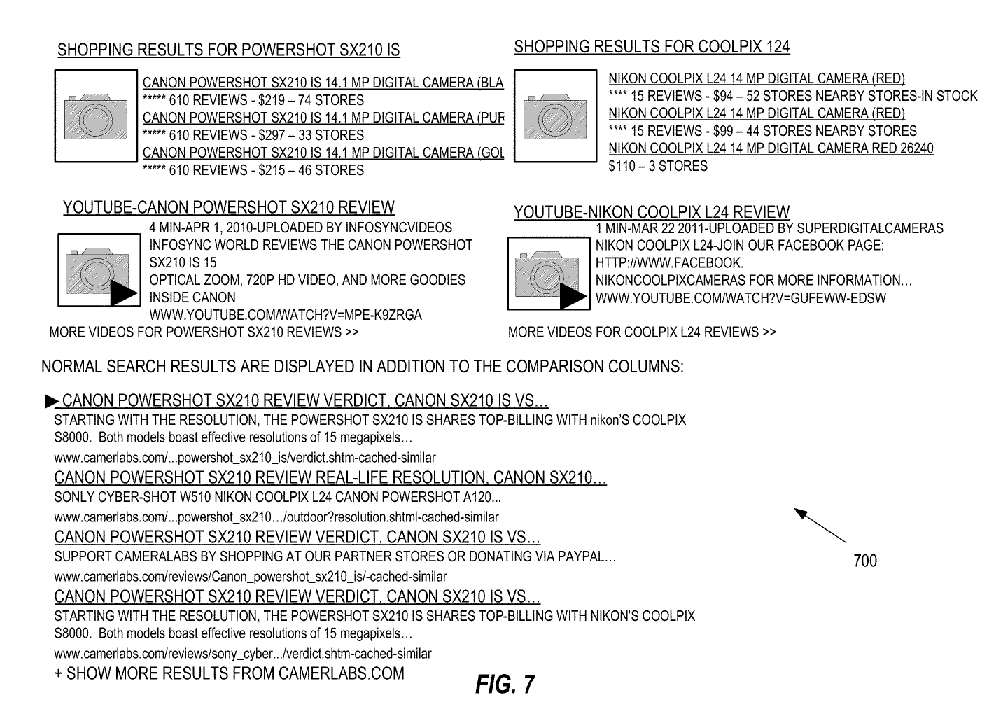

Referring now to FIG. 7, an example search result is illustrated for two cameras, “PowerShot SX210 IS versus Coolpix I100”, according to an embodiment of the present invention. Upon determining results of the queries, the search engine postprocessor aligns the two sets of results for side-by-side product comparison from various services, as shown, wherein some shopping results for the two cameras are presented side-by-side, as are results from www.YouTube.com. The search engine postprocessor also displays normal search results in addition to the comparison columns.

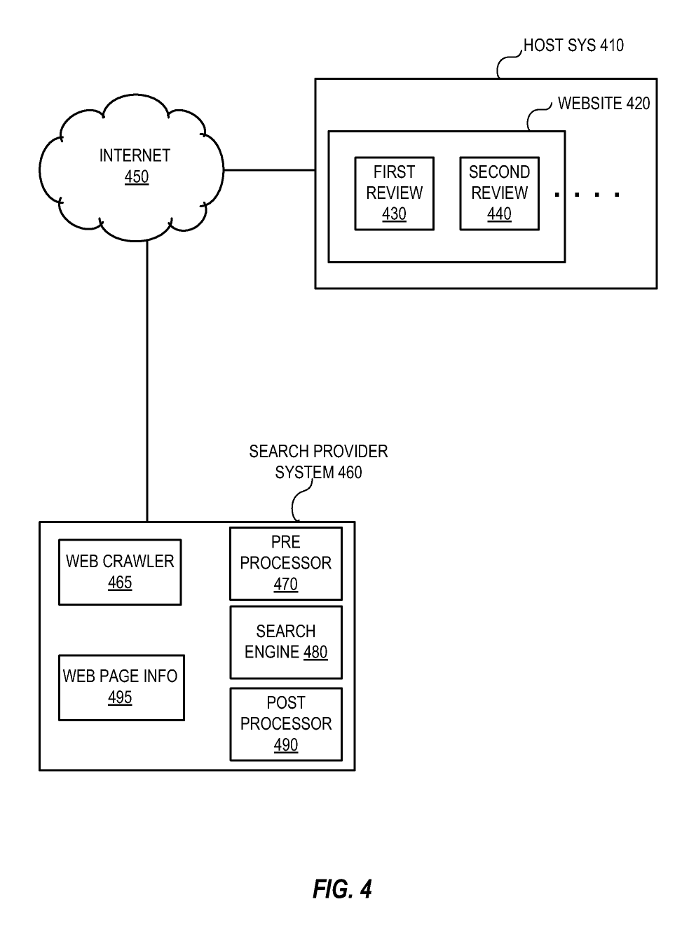

Referring now to both FIG. 6 and FIG. 4, which illustrate an embodiment of the present invention, it is notable that in an embodiment of the present invention the search engine and its pre and post processors do NOT use data that was structured to uniformly indicate attributes of the compared entities by the search provider prior to the query. Rather, the post-processor performs comparison data structuring, i.e., “adjusting,” after the search engine finds results from remote web pages, such as web pages 430 and 440. In an embodiment, web pages 430 and 440 were created and structured 610 by another, not by the search provider, and were stored previously (i.e., prior to the current search query) for the creator on a host system 410 that is remote from system 460 of the search provider. Subsequent to their creation but prior to the current search query, these pages 430 and 440 were crawled 620 by a web crawler 465 for system 460 to obtain and store information 495 about web pages 430 and 440.

Crawling remote websites such as website 420 may include saving information from the crawled websites about pages such as 430 and 440 thereon indicating that pages 430 and 440 are for reviews of products or services. Further, this data 495 collection by crawling 420 may be done without mapping attributes of the product or service reviewed on one saved page 430 to attributes of the product or service reviewed on others of the saved pages, such as page 440. Likewise, the searching 660 done by the search engine responsive to a user query may also be done without mapping attributes of the product or service reviewed on one saved page 430 to attributes of the product or service reviewed on others of the saved pages, such as page 440. This is in contrast to retailer services described above, for example, in which a retailer's system and processes (which may include those of an agent acting on behalf of the retailer) create data, or at least structure the data, for the retailer's products and in which the retailer's system and processes maintain the structured data in the retailer's back-end systems for use in comparison searches by the retailer's search engine.

To reiterate, it is notable that there does not necessarily tend to be a comparison attributes data structure that is shared in common by different review services, such as www.yelp.com, local.yahoo.com and www.judysbook.com, for example. And even within one review service, for user-generated content the data structure for one product or service description may not necessarily be as rigidly uniform as in the structured, comparison data of a retailer's back-end system. That is, web pages such as pages 430 and 440 were not necessarily created with uniform data structure for comparison.

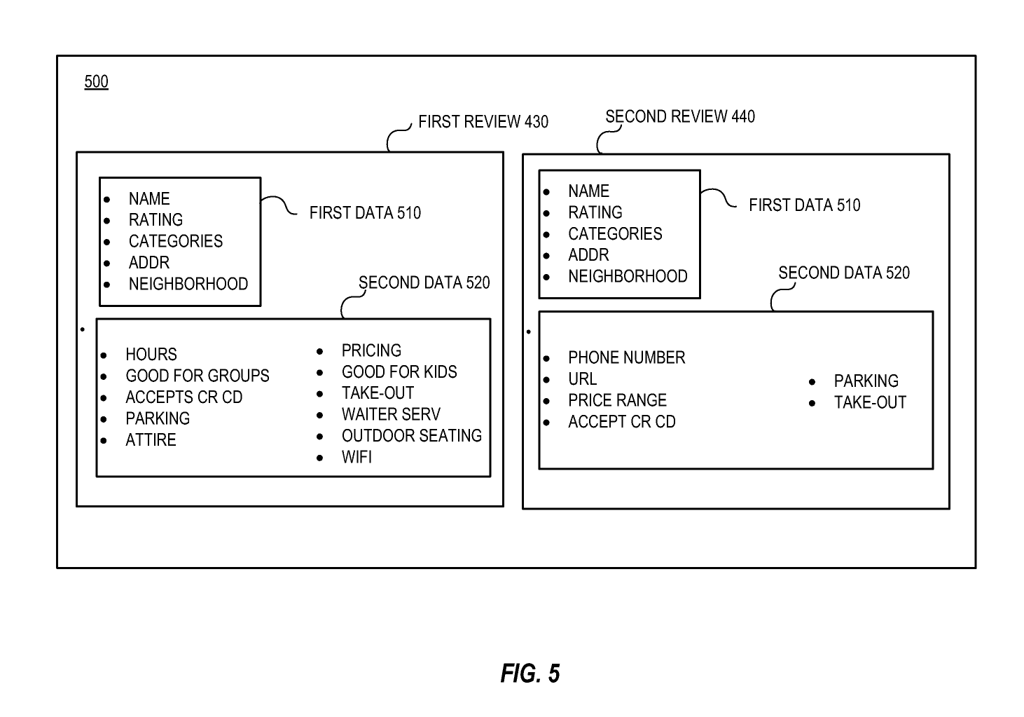

Aspects of the above described non-uniformity are illustrated in accompanying FIG. 5, showing first review 430 and second review 440 of website 420 (FIG. 4) for an embodiment of the present invention. More specifically, FIG. 5 shows an example search result that sets out first review 430 and second review 440 in alignment. Given that there has been no mapping of attributes of the product or service reviewed on one saved page 430 to attributes of the product or service reviewed on others of the saved pages, such as page 440, the aligning of the search query results side-by-side and vertically does not include aligning by reference to attributes of the review pages. Nevertheless, an embodiment of the present invention involves an insightful recognition, hereby disclosed, that within the website (e.g., website 420) for a review service, whatever structure there is to the data (page layout, features, etc.) for the same type of service or product review may approach uniformity enough to enable a remote system and search engine-related processes detailed herein to perform at least a useful heuristic comparison to itself. That is, in spite of not mapping product or service attributes to one another, the alignment of one review 430 to another review 440 tends to help the user compare the individual results although the alignment does not take into account attributes identified prior to receiving the user search query, since the results are reviews from a single website, which tend to have at least some attributes of one review page corresponding to at least some attributes of another review page and which tend to have formatting in which like attributes are in substantially the same locations on the review pages.

To use a specific example, when a user types in “restaurant 1 versus restaurant 2,” the system's search engine 480 receives the “restaurant 1” and “restaurant 2” components from preprocessor 470 and performs a search for “restaurant 1” and another search for “restaurant 2,” which may be concurrent, such that if www.yelp.com is a result for both searches, then the data for the two restaurants from www.yelp.com is compared to itself. That is, postprocessor 490 sets out the www.yelp.com restaurant review search results for each restaurant side-by-side. Because of the www.yelp.com formatting, attributes included in the reviews for the restaurants tend to be substantially aligned along the same horizontal. That is, shared attributes tend to be aligned by postprocessor 490 on horizontal lines that are proximate to one another within +/−10% of the vertical dimension of a display 500 upon which the user views the search result, enabling the user to compare the attributes to one another, since the content tends to be sufficiently similar to produce this effect.

In the illustrated instance shown in FIG. 5, the review pages 430 and 440 both have first data 510 and second data 510 presented in the substantially same location on each review page. Further, the attributes presented in first data 510 are identical for review pages 430 and 440, i.e., name, rating, categories (of food), address and neighborhood, so the attributes of first data 510 are presented in the same location on each review page, which occurs due to the layout of the pages 430 and 440 created by the web page 430 and 440 developer and not due to any mapping by any processes of the search provider system 460 (such as processes of modules 470, 480 and 490) of first data 510 on page 430 to first data 510 on page 440, or mapping by any processes of the search provider system 460 of the attributes on page 430 to attributes on page 440.

The review pages 430 and 440 also both have second data 520 and second data 510 in the same location on display 500 on each review page, which again arises due to the layout of the pages 430 and 440 created by the web page 430 and 440 developer and not due to any mapping by any processes of the search provider system 460 of second data 520 on page 430 to second data 520 on page 440. Further, the attributes presented in second data 520 are not identical for review pages 430 and 440, but they are somewhat similar. That is, in the illustrated instance 4 out of the 11 attributes presented in first data 520 for review page 430 are the same as the 6 attributes presented in first data 520 for review page 440, i.e., attributes describing price range, credit card acceptance policy, parking situation, and take-out availability. This similarity is sufficient so as to be intelligibly aligned for a useful comparison by the user simply due to the alignment of second data 520 in each page 430 and 440, i.e., an alignment created by the web developer and merely reproduced by the search processes of system 460 by rendering the pages per the developer's formatting, without system 460 mapping the individual attributes or data portions to one another.

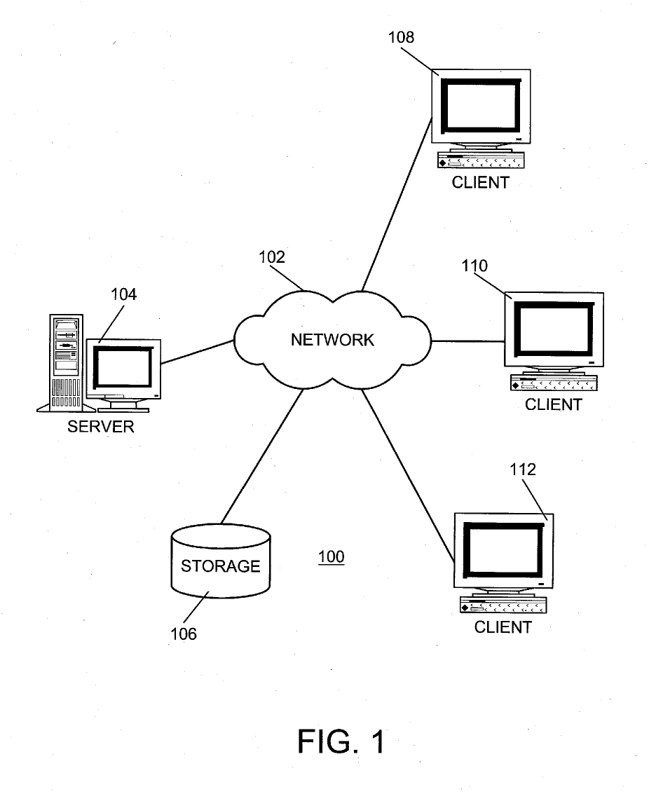

Regarding FIG. 1, a pictorial representation of a network data processing system 100 is shown in which the present invention may be implemented. Network data processing system 100 contains a network 102, which is the medium used to provide communications links between various devices and computers connected together within network data processing system 100. Network 102 may include connections, such as wire, wireless communication links, or fiber optic cables etc.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another.

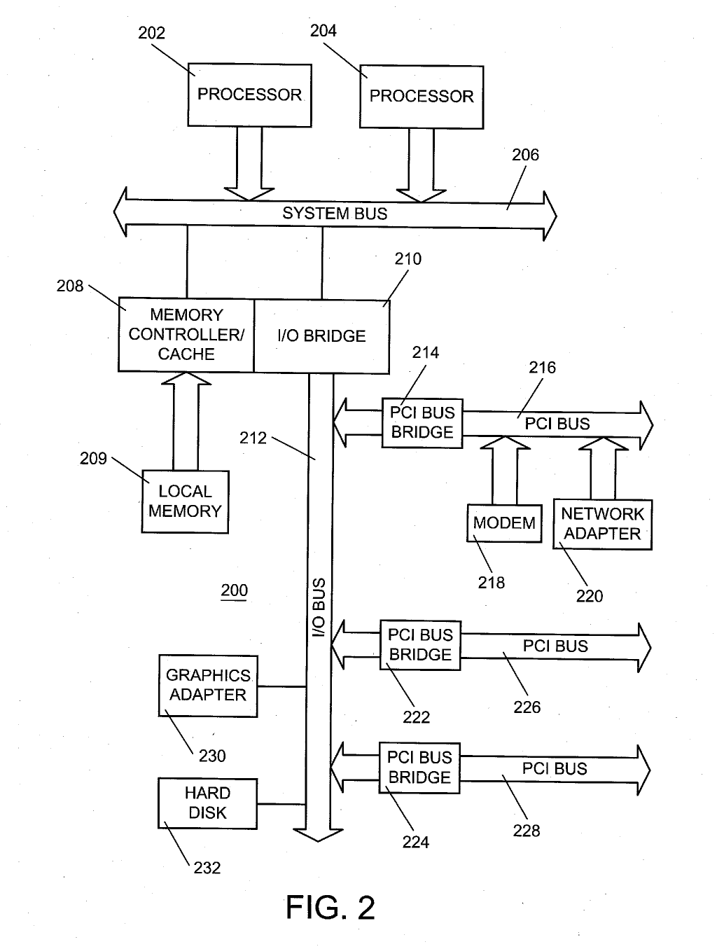

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support one or more PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM® eServer™ series system, running the IBM® AIX® operating system or LINUX® operating system. (IBM, eServer and ADC are trademarks of international Business Machines Corporation, registered in many jurisdictions worldwide. Linux is a registered trademark of Linus Torvalds in the United States, other countries, or both.)

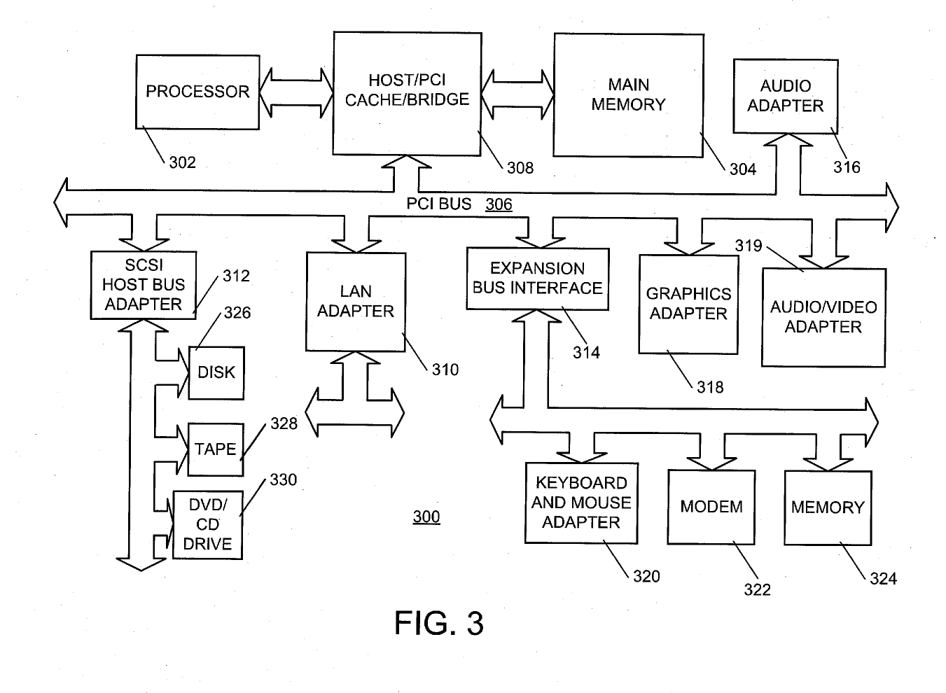

With reference now to FIG. 3, a block diagram illustrating a data processing system is depicted in which in an embodiment of the invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots.

Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support a plurality of PCI expansion slots or add-in connectors.

An operating system runs on processor 302 and is used to coordinate and provide control of various components within data processing system 300 in FIG. 3. The operating system may be any available operating system (commercial or open source). An object oriented programming system such as Java may run in conjunction with the operating system and provide calls to the operating system from Java programs or applications executing on data processing system 300. (Java and all Java-based trademarks and logos are trademarks or registered trademarks of Oracle and/or its affiliates) Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer as well as a PDA. Further, data processing system 300 may also be a kiosk or a Web appliance.

The invention is preferably local to any one, a few or all of the clients 108, 110 and 112. Nonetheless, the invention may reside on server 104, especially when the server 104 is the computer system that generates the digital image instead of just passing map data to a requesting client. Further, the present invention may reside on any data storage medium (i.e., floppy disk, compact disk, hard disk, tape, ROM, RAM, etc.) used by a computer system. (The terms “computer,” “system,” “computer system,” and “data processing system” are used interchangeably herein.)

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and program products according to embodiments of the invention. It will be understood that each block of the flowchart illustrations and/or block diagrams, and combinations of blocks in the flowchart illustrations and/or block diagrams, can be implemented by program instructions. These program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more databases may be included in a host for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. A database product that may be used to implement the databases is IBM® DB2®, or other available database products. (IBM and DB2 are trademarks of International Business Machines Corporation, registered in many jurisdictions worldwide.) The database may be organized in any suitable manner, including as data tables or lookup tables.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The host may provide a suitable website or other internet-based graphical user interface accessible by users. In one embodiment, Netscape web server, IBM® Websphere® Internet tools suite, an IBM DB2, universal database platform and a Sybase database platform are used in conjunction with a Sun Solaris operating system platform. (IBM and WebSphere are trademarks of International Business Machines Corporation, registered in many jurisdictions worldwide.) Additionally, components such as JBDC drivers, IBM connection pooling and IBM MQ series connection methods may be used to provide data access to several sources. The term webpage as it is used herein is not meant to limit the type of documents and applications that might be used to interact with the user. For example, a typical website might include, in addition to standard HTML documents, various forms, Java applets, Javascript, active server pages (ASP), Java Server Pages (JSP), common gateway interface scripts (CGI), extensible markup language (XML), dynamic HTML, cascading style sheets (CSS), helper applications, plug-ins, and the like.

The flowchart and block diagrams in the Figures illustrate the architecture, functionality, and operation of possible implementations of systems, methods and program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Note that, although the invention is shown to be used in conjunction with a conventional computer system (i.e., clients 108, 110, 112 and server 104), the invention can easily be used by any handheld device (e.g., cellular telephone, PDA etc.).

While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub combination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Those skilled in the art having read this disclosure will recognize that changes and modifications may be made to the embodiments without departing from the scope of the present invention.

It should be appreciated that the particular implementations shown and described herein are illustrative of the invention and its best mode and are not intended to otherwise limit the scope of the present invention in any way. Other variations are within the scope of the following claims.

The actions recited in the claims can be performed in a different order and still achieve desirable results. Likewise, the processes depicted in the accompanying figures do not necessarily require the particular order shown, or sequential order, to achieve desirable results. In certain implementations, multitasking and parallel processing can be advantageous.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

As used herein, the terms comprises, comprising, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be appreciated from the foregoing that embodiments have been disclosed for automatically decomposing search queries into independent components, performing concurrent searches on each component, and presenting the adjacent results in parallel to facilitate product comparisons. These embodiments may include methods, systems and computer program products having numerous advantages over the prior art, including ease of use, refinement of existing material for independent analysis of products or services, and also including breadth of search. Regarding ease of use, the disclosed embodiments enable an end user to perform search queries using their favorite search engine, rather than a new service, such as www.kayak.com.

Regarding the matter of refinement, the disclosed embodiments may access pre-existing, independent, single-product/service reviews to provide product/service comparisons even where a comparison (such as an explicit comparison review or forum post) does not currently exist. Thus, regarding breadth of search, the disclosed embodiments make the entire Worldwide Web available for comparisons, rather than being limited to comparison descriptions of products or services by a particular supplier. Also regarding breadth, the search comparison results provided by disclosed embodiments are not limited to just a few categories of products/services, such as hotels, car rentals and airlines.

The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should be appreciated that in a feature of one or more embodiments of the invention, finding the individual result for each respective, individual component from a single, remote website includes finding an individual review for each respective, individual component from a single, remote website, wherein since the results are respective reviews, the alignment further tends to help the user compare the individual results.

In another aspect, the method includes crawling remote websites and saving information from the crawled websites about pages thereon that review products or services. The method does not include mapping attributes of a product or service on ones of the saved pages to attributes of a product or service on others of the saved pages. The aligning of the search query results side-by-side and vertically aligns without reference to attributes of the review pages and the aligning. Nevertheless, the aligning tends to help the user compare the individual results, since the single website tends to have at least some attributes of one review page corresponding to at least some attributes of another review page and tends to have formatting in which like attributes are in substantially the same locations on the review pages.

In another aspect, performing the respective component queries for the respective, individual components includes finding text snippets in the respective, individual reviews that refer to a topic, and wherein aligning the results side-by-side and vertically includes aligning the text snippets.

In another aspect, the request for a comparison-mode query is an implied request and wherein detecting terms in the search query indicating that the query includes a request for a comparison-mode query includes natural language processing of the terms included in the query.

In another aspect, performing the respective component queries for the respective, individual components includes performing the respective component queries concurrently.

In another aspect, presenting to a user the individual results of the component queries includes presenting to a user the individual query results in a preview.

1. A method for providing search results in response to a search query, comprising:
receiving, by a processor, a search query from a user;
detecting, by the processor, that the search query includes a request for a comparison-mode query and the processor automatically detecting terms in the search query indicating that the query includes first and second components;
decomposing the comparison-mode query into respective, individual component queries for the respective components; and
performing the comparison-mode query, including:
performing the respective component queries for the respective, individual components, including the processor finding a first individual result for each respective, individual component from a first, remote website, and
presenting automatically by the processor to the user in a search result page the individual results of the component queries, including aligning, on the search result page, the first result from the first website for the first component with the first result from the first website for the second component, so that the alignment of results from the first website tends to help the user compare the individual results, although the results from the first website are for respective, individual components.

2. The method of claim 1, wherein finding the first, individual result for each respective, individual component from a first, remote website includes:
finding a first, individual review for each respective, individual component from a first, remote website, wherein since the results include information from respective review web pages, the alignment further tends to help the user compare the individual results.

3. The method of claim 2, comprising:
crawling remote websites and saving information from the crawled websites about review web pages thereon that review products or services, wherein the method does not include mapping attributes of a product or service on ones of the saved pages to attributes of a product or service on others of the saved pages, wherein the aligning of the search query results aligns without reference to attributes of the review web pages and the aligning, nevertheless, tends to help the user compare the individual results, since the single website tends to have at least some attributes of one review web page corresponding to at least some attributes of another review web page and tends to have formatting in which like attributes are in substantially the same locations on the review web pages.

4. The method of claim 2, wherein performing the respective component queries for the respective, individual components includes finding text snippets in the respective, individual reviews that refer to a topic, and wherein aligning the results includes aligning the text snippets.

5. The method of claim 2, wherein the request for a comparison-mode query is an implied request and wherein detecting terms in the search query indicating that the query includes a request for a comparison-mode query includes natural language processing of the terms included in the query.

6. The method of claim 2, wherein performing the respective component queries for the respective, individual components includes performing the respective component queries concurrently.

7. The method of claim 2, wherein presenting to a user the individual results of the component queries includes presenting to a user the individual query results in a preview.

8. A computer system comprising:
a computer readable storage medium; and
at least one processor;
the computer readable storage medium having instructions for execution by the at least one processor;
wherein the computer system is configured with the instructions and the at least one processor to provide search results in response to a search query, wherein the providing the search results comprises:
receiving, by the processor, a search query from a user;
detecting, by the processor, that the search query includes a request for a comparison-mode query and the processor automatically detecting terms in the search query indicating that the query includes first and second components;
decomposing the comparison-mode query into respective, individual component queries for the respective components; and
performing the comparison-mode query, including:
performing the respective component queries for the respective, individual components, including the processor finding a first individual result for each respective, individual component from a first, remote website, and
presenting automatically by the processor to the user in a search result page the individual results of the component queries, including aligning, on the search result page, the first result from the first website for the first component with the first result from the first website for the second component, so that the alignment of results from the first website tends to help the user compare the individual results, although the results from the single website are for respective, individual components.

9. The system of claim 8, wherein finding the first individual result for each respective, individual component from a first, remote website includes:
finding a first individual review for each respective, individual component from a first, remote website, wherein since the results include information from respective review web pages, the alignment further tends to help the user compare the individual results.

10. The system of claim 9, wherein providing the search results comprises:
crawling remote websites and saving information from the crawled websites about review web pages thereon that review products or services, wherein the method does not include mapping attributes of a product or service on ones of the saved pages to attributes of a product or service on others of the saved pages, wherein the aligning of the search query results aligns without reference to attributes of the review web pages and the aligning, nevertheless, tends to help the user compare the individual results, since the single website tends to have at least some attributes of one review web page corresponding to at least some attributes of another review web page and tends to have formatting in which like attributes are in substantially the same locations on the review web pages.

11. The system of claim 9, wherein performing the respective component queries for the respective, individual components includes finding text snippets in the respective, individual reviews that refer to a topic, and wherein aligning the includes aligning the text snippets.

12. The system of claim 9, wherein the request for a comparison-mode query is an implied request and wherein detecting terms in the search query indicating that the query includes a request for a comparison-mode query includes natural language processing of the terms included in the query.

13. The system of claim 9, wherein performing the respective component queries for the respective, individual components includes performing the respective component queries concurrently.

14. The system of claim 9, wherein presenting to a user the individual results of the component queries includes presenting to a user the individual query results in a preview.

15. A computer program product for providing search results in response to a search query, the computer program product comprising:
a computer-readable storage medium having computer-readable program code embodied therewith, the computer readable program code comprising:
computer readable program code configured to:
receive, by a processor, a search query from a user;
detect, by the processor, that the search query includes a request for a comparison-mode query and the processor automatically detecting terms in the search query indicating that the query includes first and second components;
decompose the comparison-mode query into respective, individual component queries for the respective components; and
perform the comparison-mode query, including:
performing the respective component queries for the respective, individual components, including the processor finding a first individual result for each respective, individual component from a first, remote website, and
presenting automatically by the processor to the user in a search result page the individual results of the component queries, including aligning on the search result, page, the first result from the first website for the first component with the first result from the first website for the second component, so that the alignment of results from the first website tends to help the user compare the individual results, although the results from the first website are for respective individual components.

16. The computer program product of claim 15, wherein finding a first individual result for each respective, individual component from a first, remote website includes:
finding a respective, first individual review for each respective, individual component from a first, remote website, wherein since the results include information from respective review web pages, the alignment further tends to help the user compare the individual results.

17. The computer program product of claim 16, wherein the computer readable program code is configured to:
crawl remote websites and saving information from the crawled websites about review web pages thereon that review products or services, wherein the method does not include mapping attributes of a product or service on ones of the saved pages to attributes of a product or service on others of the saved pages, wherein the aligning of the search query results aligns without reference to attributes of the review web pages and the aligning, nevertheless, tends to help the user compare the individual results, since the single website tends to have at least some attributes of one review web page corresponding to at least some attributes of another review web page and tends to have formatting in which like attributes are in substantially the same locations on the review web pages.

18. The computer program product of claim 16, wherein performing the respective component queries for the respective, individual components includes finding text snippets in the respective, individual reviews that refer to a topic, and wherein aligning the results includes aligning the text snippets.

19. The computer program product of claim 16, wherein the request for a comparison-mode query is an implied request and wherein detecting terms in the search query indicating that the query includes a request for a comparison-mode query includes natural language processing of the terms included in the query.

20. The computer program product of claim 16, wherein performing the respective component queries for the respective, individual components includes performing the respective component queries concurrently.

21. The computer program product of claim 16, wherein presenting to a user the individual results of the component queries includes presenting to a user the individual query results in a preview.
